(19) United States
(12) Patent Application Publication
(10) Pub. No.: US 2011/0075180 A1
(43) Pub. Date: Mar. 31, 2011

(54) IMAGE PROCESSING APPARATUS THAT INSTRUCTS OUTPUT OF READ IMAGE DATA, METHOD OF CONTROLLING THE SAME, AND STORAGE MEDIUM

(75) Inventor: Hiroaki KOIKE, Kokubunji-shi (JP)

(73) Assignee: CANON KABUSHIKI KAISHA, Tokyo (JP)

(21) Appl. No.: 12/894,639

(22) Filed: Sep. 30, 2010

(30) Foreign Application Priority Data
Sep. 30, 2009 (JP) 2009-227130

(51) Int. Cl. G06F 3/12

(52) U.S. Cl. 358/1.13

(57) ABSTRACT

An image processing apparatus which is capable of reducing time and labor to configure detailed settings of an output-side device at a read-side device. A controller unit selects an output-side device, requests the selected output-side device to transmit information on output settings, receives the requested information on the output settings and limiting conditions on the reading settings for executing the output settings, executes reading of image data based on the reading settings with the received limiting conditions, and transmits the read image data and the information on the output settings to the output-side device.

### BACKGROUND OF THE INVENTION

1. Field of the Invention

The present invention relates to an image processing apparatus that instructs output of read image data, a method of controlling the image processing apparatus, and a storage medium, and more particularly to an image processing apparatus characterized by a device (apparatus) collaboration technique used when the reading of image data and the outputting of the read data are performed by respective different devices (image processing apparatuses), a method of controlling the image processing apparatus, and a non-transitory computer-readable storage medium storing a computer-executable program which causes a computer to execute the method.

2. Description of the Related Art

Conventionally, there has been proposed a technique for giving a print instruction to a printing apparatus selected from a plurality of printing apparatuses on a network, via a display screen (print instruction screen). Further, there has been proposed a technique in which when giving the print instruction, print instruction information set via the print instruction screen is stored for later use to enable setting items of print instruction to be set by selecting an item of print instruction information from stored items of print instruction information (Japanese Patent Laid-Open Publication No. H08-278865).

Further, there has also been proposed a technique for controlling an output-side apparatus by configuring output settings using an input-side apparatus, and causing the output-side apparatus to perform error judgment (Japanese Patent Laid-Open Publication No. 2004-326388).

In the conventional technique, the print instruction information set via the print instruction screen is stored, and the setting items of print instruction are set by selecting one of the stored items of print instruction information. However, to configure the settings via the print instruction screen, it is necessary to display the print instruction screen in a manner adapted to the printing apparatus.

To prepare the print instruction screen adapted to the printing apparatus as mentioned above, it is necessary to store all information on the functions of the printing apparatus and the mutually exclusive conditions of the functions. Therefore, when a new function is added to the printing apparatus, for example, it is sometimes necessary to add or update a definition associated with the newly added function.

Further, in a case where output settings are configured from an apparatus other than an output-side apparatus, and error judgment is performed by the output-side apparatus, the error judgment is executed only at a stage where a job is input after configuring all the output settings. Therefore, it is not possible to prevent an error before inputting the job.

### SUMMARY OF THE INVENTION

The present invention provides an image processing apparatus, and a method of controlling the image processing apparatus, which are capable of reducing time and labor to configure detailed settings of an output-side device at a read-side device, and a non-transitory computer-readable storage medium storing a computer-executable program which causes a computer to execute the method.

In a first aspect of the present invention, there is provided an image processing apparatus as a read-side device that reads image data, and instructs an output-side device to output the read image data, comprising a selection unit configured to select the output-side device, a request unit configured to request the output-side device selected by the selection unit to transmit information on output settings, a reception unit configured to receive the information on the output settings requested by the request unit and limiting conditions on reading settings for executing the output settings, from the output-side device, an execution unit configured to execute reading of image data based on the reading settings with the limiting conditions received by the reception unit, and a transmission unit configured to transmit the image data read by the execution unit and the information on the output settings, to the output-side device.

In a second aspect of the present invention, there is provided a method of controlling an image processing apparatus as a read-side device that reads image data, and instructs an output-side device to output the read image data, comprising selecting the output-side device, requesting the output-side device selected by the selecting to transmit information on output settings, receiving the information on the output settings requested by the requesting and limiting conditions on reading settings for executing the output settings, from the output-side device, executing reading of image data based on the reading settings with the limiting conditions received by the receiving, and transmitting the image data read by the executing and the information on the output settings, to the output-side device.

In a third aspect of the present invention, there is provided a non-transitory computer-readable storage medium storing a computer-executable program for causing a computer to execute a method of controlling an image processing apparatus as a read-side device that reads image data, and instructs an output-side device to output the read image data, wherein the method comprises selecting the output-side device, requesting the output-side device selected by the selecting to transmit information on output settings, receiving the information on the output settings requested by the requesting and limiting conditions on reading settings for executing the output settings, from the output-side device, executing reading of image data based on the reading settings with the limiting conditions received by the receiving, and transmitting the image data read by the executing and the information on the output settings, to the output-side device.

According to the present invention, it is possible to reduce time and labor to configure detailed settings of the output-side device at the read-side device.

Further features of the present invention will become apparent from the following description of exemplary embodiments with reference to the attached drawings.

### BRIEF DESCRIPTION OF THE DRAWINGS

FIG. 1 is a system block diagram showing essential parts of a digital multifunction peripheral as an image processing apparatus (image forming apparatus) according to an embodiment of the present invention.

FIGS. 2A and 2B illustrate an outline of a device collaboration process executed by the digital multifunction peripheral on a read side (device A) as the image processing apparatus according to the embodiment shown in FIG. 1, and a digital multifunction peripheral an output side (device B) on which has the same configuration as the device A.

FIGS. 3A and 3B are a flowchart of a read-side device collaboration process executed by the digital multifunction peripheral on the read side (device A) as the image processing apparatus according to the embodiment shown in FIG. 1 in collaboration with the digital multifunction peripheral on the output side (device B) which has the same configuration as the device A.

FIG. 4 illustrates hard keys of an operating section appearing in FIG. 1.

FIG. 5 illustrates a basic screen displayed on a display of the operating section.

FIG. 6 illustrates changes in displayed screens on the display of the operating section.

FIGS. 7A and 7B are a flowchart of a first variation of the read-side device collaboration process executed by the digital multifunction peripheral on the read side (device A) as the image processing apparatus according to the embodiment shown in FIG. 1 in collaboration with the digital multifunction peripheral on the output side (device B) which has the same configuration as the device A.

FIG. 8 illustrates a message screen displayed in a step S302 in FIG. 7B.

FIGS. 9A and 9B are a flowchart of a second variation of the read-side device collaboration process executed by the digital multifunction peripheral on the read side (device A) as the image processing apparatus according to the embodiment shown in FIG. 1 in collaboration with the digital multifunction peripheral on the output side (device B) which has the same configuration as the device A.

FIG. 10 illustrates an error screen displayed in a step S401 in FIG. 9B.

FIG. 11 is a flowchart of a newly added process portion of a third variation of the read-side device collaboration process executed by the digital multifunction peripheral on the read side (device A) as the image processing apparatus according to the embodiment shown in FIG. 1 in collaboration with the digital multifunction peripheral on the output side (device B) which has the same configuration as the device A.

### DETAILED DESCRIPTION OF THE EMBODIMENTS

The present invention will now be described in detail below with reference to the accompanying drawings showing embodiments thereof.

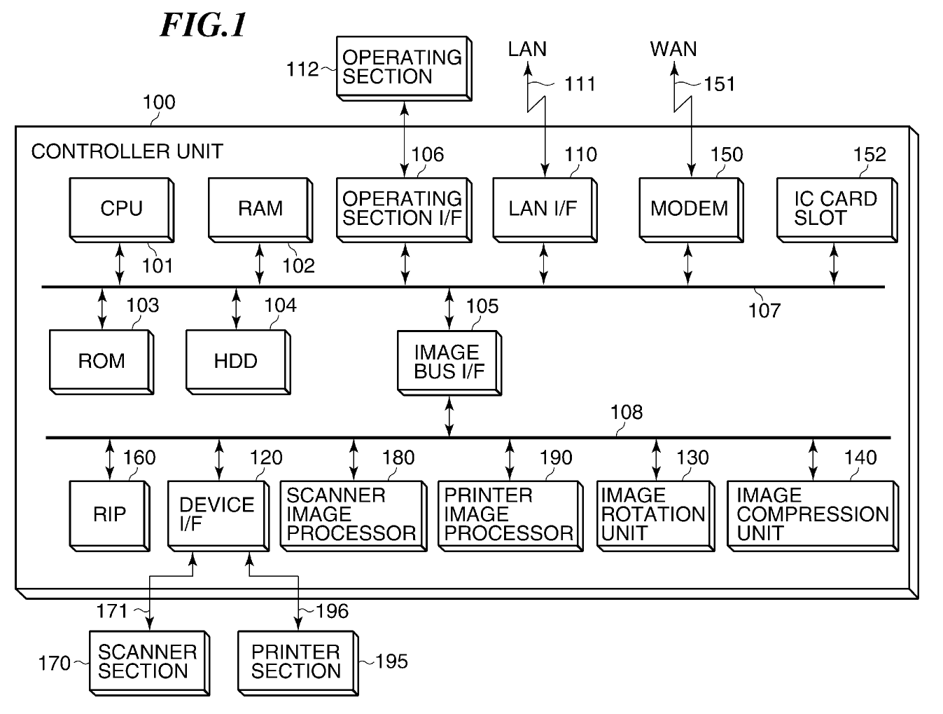

FIG. 1 is a system block diagram showing essential parts of an image processing apparatus according to an embodiment of the present invention.

It should be noted that in the present embodiment, a description will be given of a digital multifunction peripheral equipped with a copy function, a print function, and a facsimile function, as an example of the image processing apparatus according to the embodiment.

The digital multifunction peripheral includes a controller unit 100 which controls the overall operation of the apparatus and controls input and output of image information and device information. A scanner section 170, a printer section 195, a LAN (Local Area Network) 111, and a WAN (Wide Area Network) 151 such as a public communication line, are connected to the controller unit 100.

The digital multifunction peripheral has the copy function, the printer function for printing out data supplied from the outside via the LAN 111, and the communication function including the facsimile function via the WAN 151 such as the public communication line.

The controller unit 100 starts the system based on a boot program stored in a ROM 103. The controller unit 100 includes the following devices.

The controller unit 100 has a CPU (Central Processing Unit) 101 that reads various control programs stored in a HDD (Hard Disk Drive) 104, and executes predetermined processes using a RAM (Random Access Memory) 102 as a work area. The HDD 104 stores the programs and image data.

Not only the RAM 102, the ROM (Read Only Memory) 103, and the HDD 104 but also an operating section interface 106 are connected to the CPU 101 via a system bus 107. Further, a LAN interface 110, a modem 150, an image bus interface 105, and an IC card slot 152 are also connected to the CPU 101 via the system bus 107.

The operating section interface 106 provides interface with an operating section 112, and transfers image data to be displayed on the operating section 112 to the operating section 112, and a signal generated by an inputting operation via the operating section 112 to the CPU 101. The operating section 112 includes a display section, not shown, for displaying current settings of functions concerning image formation (image processing), information input screens for inputting configuration information on the functions, and so forth, and an input section, not shown, including keys for inputting configuration information on the functions.

The LAN interface 110 is connected to the LAN 111, and inputs and outputs information via the LAN 111. The modem 150 is connected to the WAN 151 such as the public communication line, and inputs and outputs information through the WAN 151. The image bus interface 105 connects an image bus 108 to the system bus 107, and comprises a bus bridge that converts data structure. The image bus 108 is implemented e.g. by a PCI bus that is capable of transmitting image data at a high speed or by a bus conforming to the IEEE 1394 standard.

To the image bus 108 are connected a RIP (Raster Image Processor) 160, a device interface 120, a scanner image processor 180, a printer image processor 190, an image rotation unit 130, and an image compression unit 140.

The RIP 160 rasterizes a PDL code into a bitmap image. The device interface 120 connects the scanner section 170 as an image input device and the printer section 195 as an image output device to the controller unit 100, and converts image data between synchronous and asynchronous systems. In this embodiment, the device interface 120 and the scanner section 170 are connected to each other via a cable 171, and the device interface 120 and the printer section 195 are connected to each other via a cable 196.

The scanner image processor 180 corrects, processes and edits the inputted image data. The printer image processor 190 performs the correction and resolution conversion of image data to be printed out by the printer section 195. The image rotation unit 130 rotates image data. The image compression unit 140 performs JPEG compression/expansion for multivalued image data, and JBIG, MMR or MH compression/expansion processes for binary image data.

Thus, the CPU 101 of the controller unit 100 performs centralized control over access to and from a variety of devices connected to the system bus 107 based on control programs. Further, the CPU 101 performs a control operation for reading image information from the scanner section 170 via the device interface 120, executing predetermined processing on the read image information, and then delivering the image information to the printer section 195 via the device interface 120, and like other control operations.

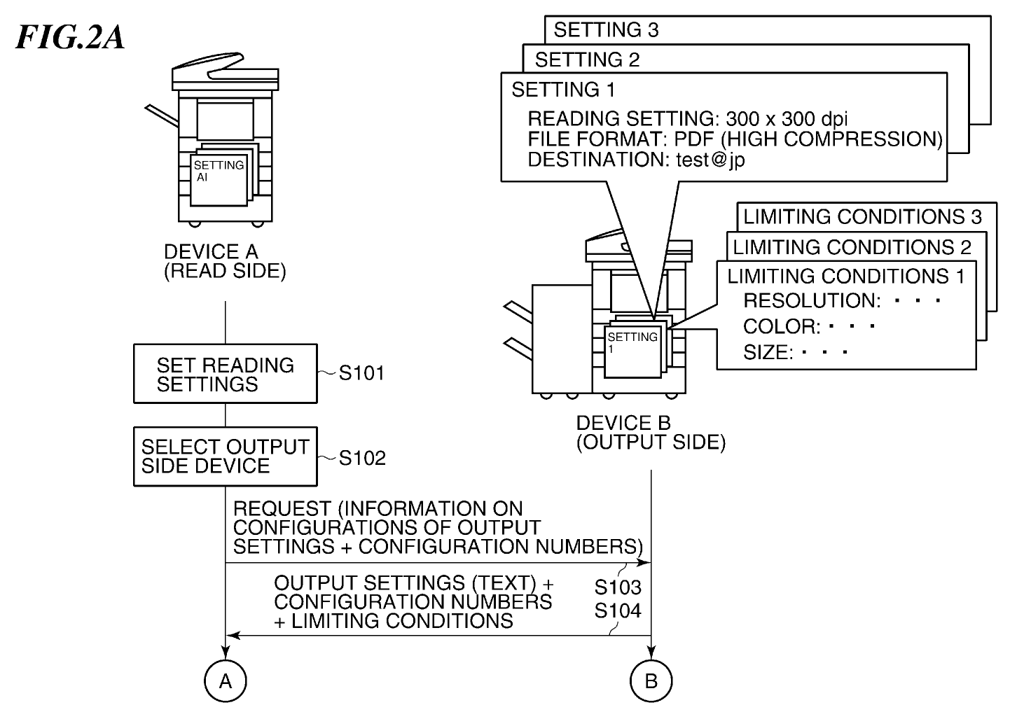

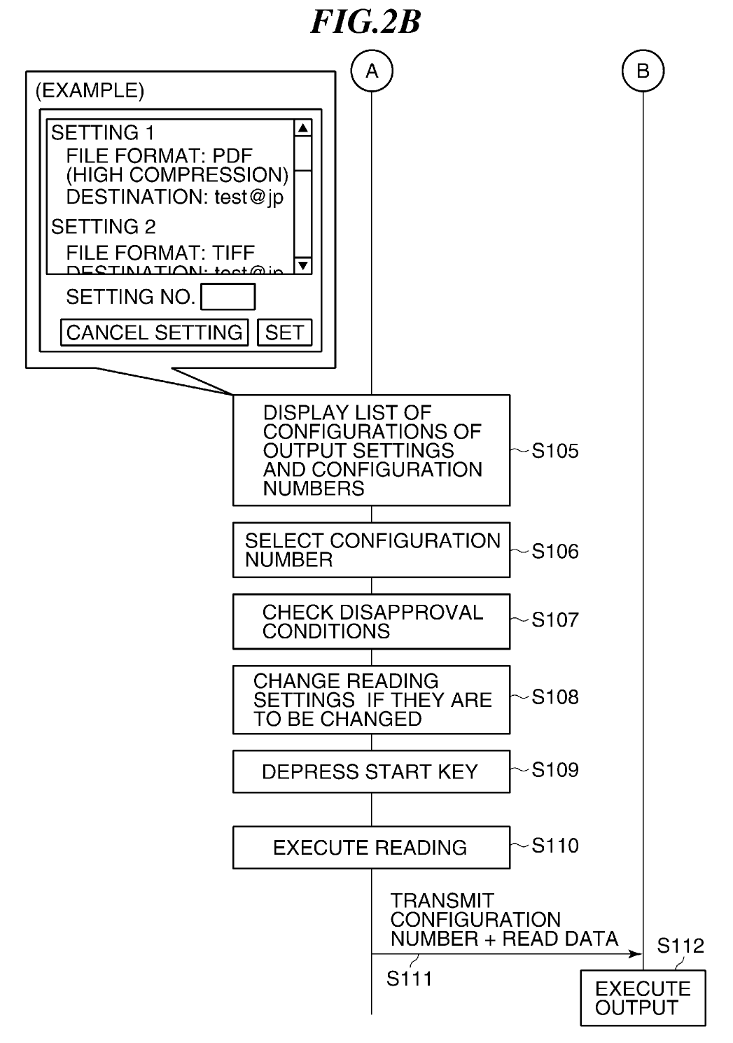

FIGS. 2A and 2B illustrate an outline of a device collaboration process executed by a digital multifunction peripheral (device A) on a read side as the image processing apparatus according to the embodiment shown in FIG. 1, and a digital multifunction peripheral on the output side (device B) which has the same configuration as the device A. [0039] In this process, it is assumed that the read-side device have information on the configurations of reading settings registered and stored in the HDD 104 of its own, in advance, and the output-side device have information on the configurations of output settings registered and stored in the HDD 104 of its own, in advance.

In the device A, first, one configuration of reading settings is selected from the stored information on the configurations of reading settings to set the reading settings (step S101), and an output-side device is selected (step S102). Then, the device A makes a request for information on the configurations of output settings and configuration numbers associated with the respective configurations, to the device B (step S103). In response to this request, the device B returns a response with an attachment of limiting conditions (step S104).

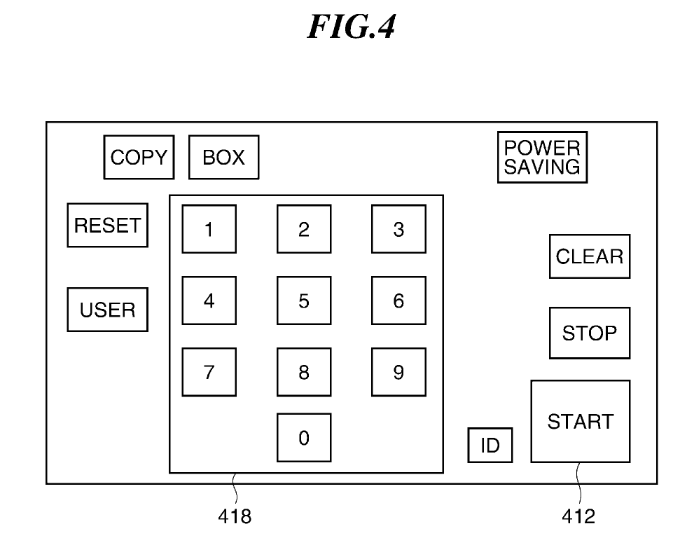

In the device A, a list of the configurations of output settings and associated configuration numbers are displayed (step S105), and then there are performed selection of a setting configuration number (step S106), a check on disapproval conditions (step S107), and a change of the settings, if required (step S108). Then, a start key 412 of the operating section 112 appearing in FIG. 4 is depressed to instruct the execution of a job (step S109). Then, the device A executes the job, i.e. reading of data (step S110), and transmission of the data to the device B (step S111) for printout. The device B executes output of the data (step S112).

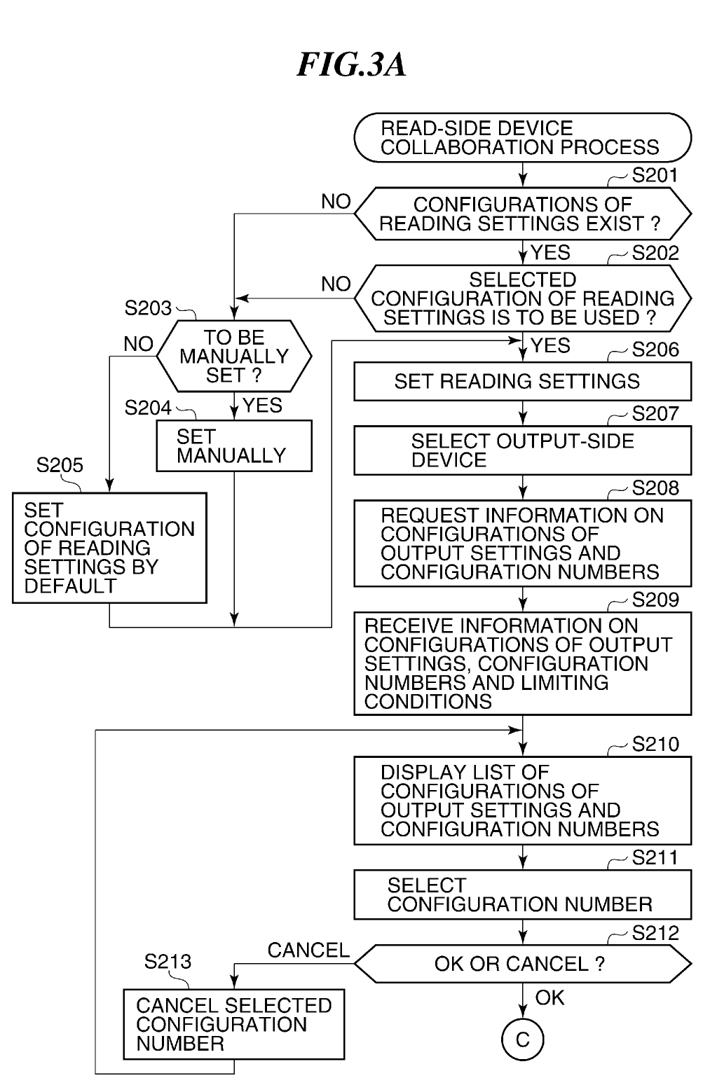

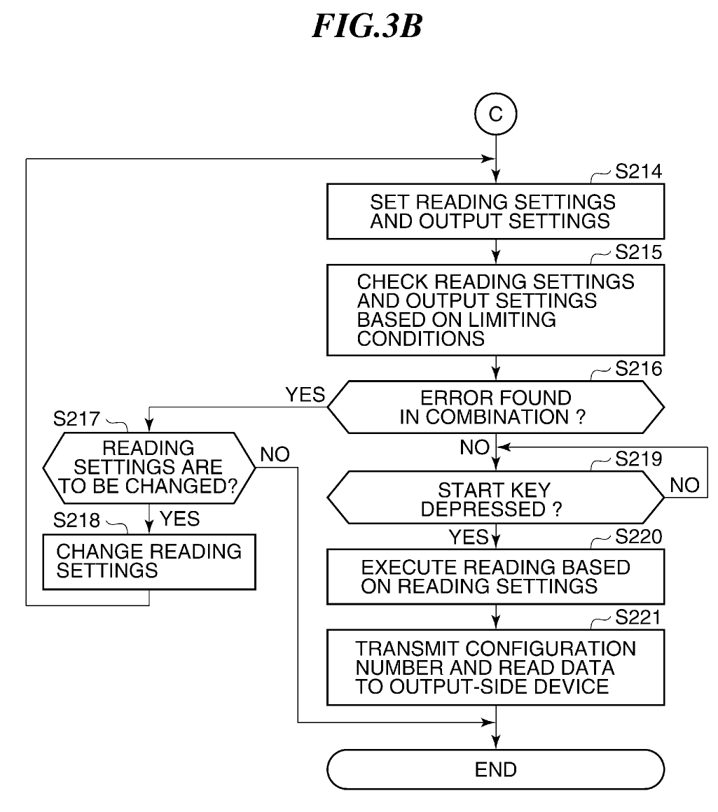

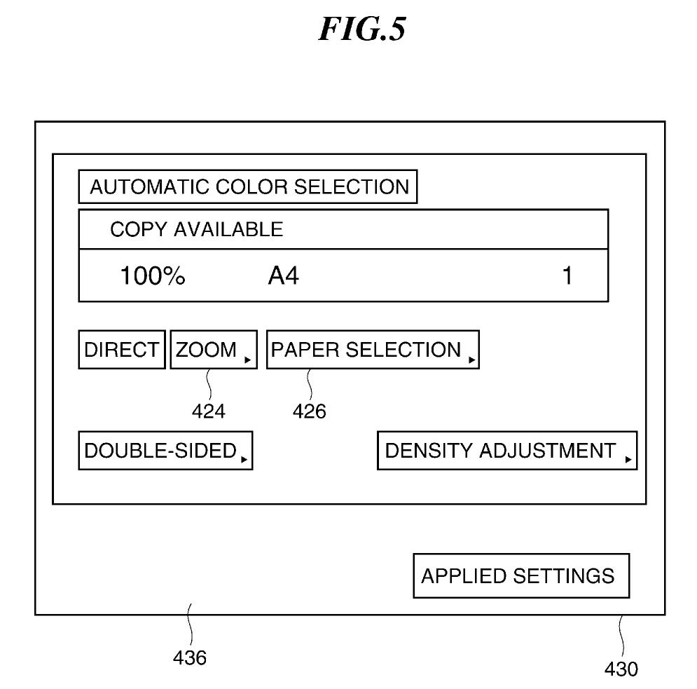

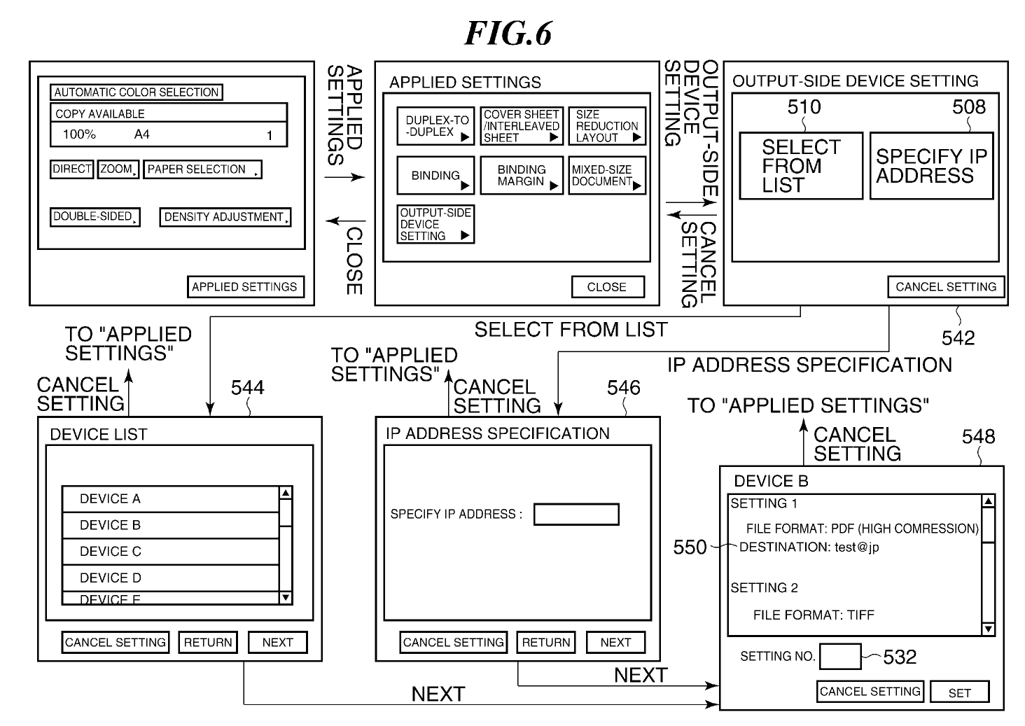

FIGS. 3A and 3B are a flowchart of a read-side device collaboration process executed by the digital multifunction peripheral (device A) on the read side as the image processing apparatus according to the embodiment shown in FIG. 1 in collaboration with the digital multifunction peripheral on the output side (device B) which has the same configuration as the device A. The present process is executed by the CPU 101 by reading an associated program from the HDD 104 and loading the same into the RAM 102. FIG. 4 illustrates hard keys of the operating section 112 appearing in FIG. 1. FIG. 5 illustrates a basic screen displayed on a display 430 of the operating section 112. FIG. 6 illustrates changes in displayed screens on the display 430 of the operating section 112.

Referring to FIGS. 3A and 3B, in a step S201, the CPU 101 determines whether or not there are stored configurations of reading settings in the read-side device. If it is determined in this step that there are stored no configurations of reading settings, the CPU 101 determines in a step S203 whether or not the reading settings are to be manually configured.

If it is determined in the step S203 that the reading settings are to be manually configured, the process proceeds to a step S204, wherein the reading settings are manually configured from a setting screen 436 shown in FIG. 5, and then proceeds to a step S206.

If it is determined in the step S203 that the reading settings are not to be manually configured, the process proceeds to a step S205, wherein the reading settings are configured by default, and then proceeds to the step S206.

If it is determined in the step S201 that there are stored configurations of the reading settings, the process proceeds to a step S202, wherein it is determined whether or not one of the stored configurations of the reading settings is to be used, and if it is determined that none of them are to be used, the process proceeds to the aforementioned step S203.

If it is determined in the step S202 that one of the stored configurations of reading settings is to be used, the process proceeds to the step S206, wherein the one configuration of reading settings is set.

Next, in a step S207, an output-side device is selected. In this step, to select an output-side device, for example, first, selection is made from an output-side setting screen 542 (see FIG. 6) whether to designate an output-side device by an IP address or select one from a displayed list.

If designation by an IP address is selected (by a button 508 in the output-side setting screen 542), an IP address is input from an IP address designation screen 546 appearing in FIG. 6. The IP address can be input using a ten-key 418 (see FIG. 4).

In the output-side setting screen 542, if selection from the list is selected (by a button 510 in the output-side setting screen 542), it is possible to select an output-side device from a device list screen 544 appearing in FIG. 6, which displays a list of neighboring or preset devices.

Next, in a step S208, information on the configurations of output settings and configuration configuration numbers associated with the configurations are requested from the read-side device to the output-side device.

Next, in a step S209, the read-side device receives from the output-side device the information on the configurations of output settings, the associated configuration numbers, and the limiting conditions on the configuration of reading settings for executing each of the configurations of output settings.

In this step, the limiting conditions include items which cannot be set due to the difference between a black-and-white device and a color device, and a reading resolution, a reading color, and a reading size which cannot be set when executing the selected configuration of output settings.

Next, in a step S210, a list of the configurations of output settings and the configuration numbers associated with the respective configurations, received in the step S209, is displayed. This makes it possible for the user to select one configuration from the list.

After each configuration of output settings displayed on the list in the step S210 is confirmed, and a configuration number associated with a configuration of output settings which the user desires to use is selected in a step S211. The displaying of the list of the configurations of output settings and associated configuration numbers and the selection of a configuration number associated with a desired configuration are performed on an output setting configuration selection screen 548 appearing in FIG. 6. The configuration of the output settings associated with the respective configuration numbers can be confirmed by an output setting configuration list 550 in the output setting configuration selection screen 548, and by inputting a configuration number to a configuration number entry box 532, it is possible to select a configuration of output settings for use.

Next, the process proceeds to a step S212, wherein it is determined whether or not the configuration number selected in the step S211 is finally determined. If it is determined that the selected configuration number is not finally determined, the selection of the configuration number is canceled in a step S213, and then the process returns to the step S210 to repeat the above process.

If it is determined in the step S212 that the selected configuration number is finally determined, the process proceeds to a step S214, wherein the configuration of reading settings at the read-side device and the configuration of output settings at the output-side device are set (combined).

Next, in a step S215, the configuration of reading settings and that of output settings, set in the step S212, are checked based on the limiting conditions received in the step S209.

As a result of the check in the step S215, it is determined in a step S216 whether or not there is any error found in the combination.

If it is determined in the step S216 that there is an error found in the combination, it is determined in a step S217 whether or not to change the configuration of reading settings.

If it is determined in the step S217 that the configuration of reading settings is to be changed, the process proceeds to a step S218, wherein, for example, a screen, not shown, for changing the configuration of reading settings is displayed, and the configuration of reading settings is changed based on an instruction by the user. Then, the process proceeds to the step S214 to repeat the above process.

If it is determined in the step S217 that the configuration of reading settings is not to be changed, the present process is immediately terminated.

If it is determined in the step S216 that there is no error found in the combination, the process proceeds to a step S219 wherein it is determined whether or not the start key 412 of the operating section 112 appearing in FIG. 4 is depressed to instruct the start of the job. If it is determined that the start key 412 is depressed, the present process proceeds to a step s220, whereas if not, the depression of the start key 412 is awaited.

In the step S220, the reading of data is executed based on the reading settings of the selected configuration. Then, the process proceeds to a step S221, wherein the configuration number associated with the configuration of output settings and the read data are transmitted to the output-side device, followed by terminating the present process.

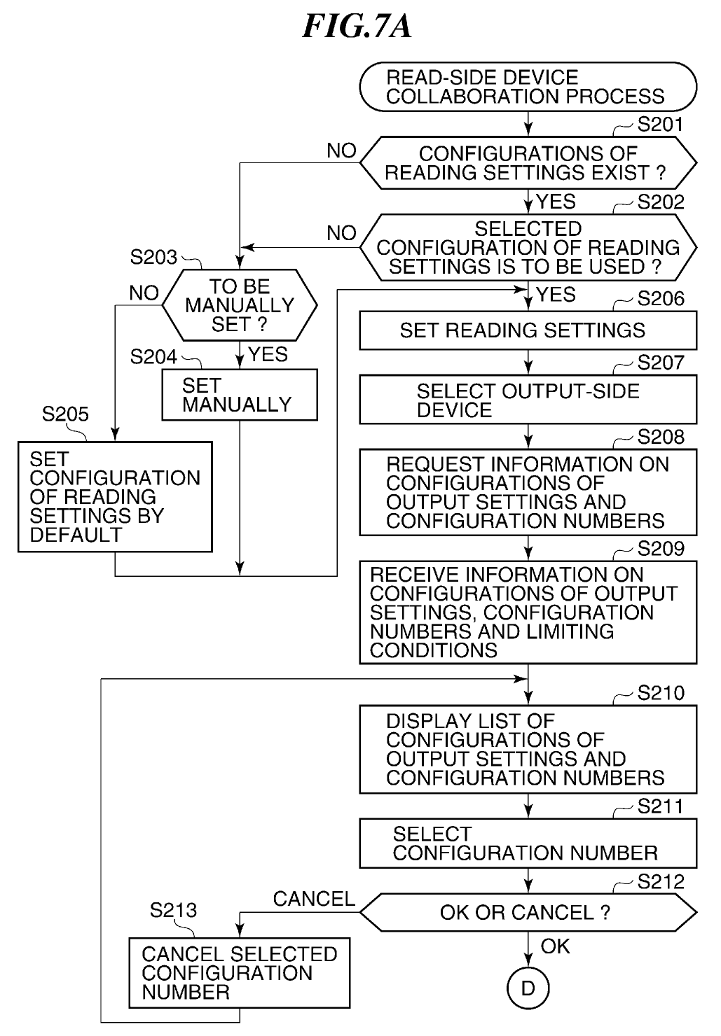

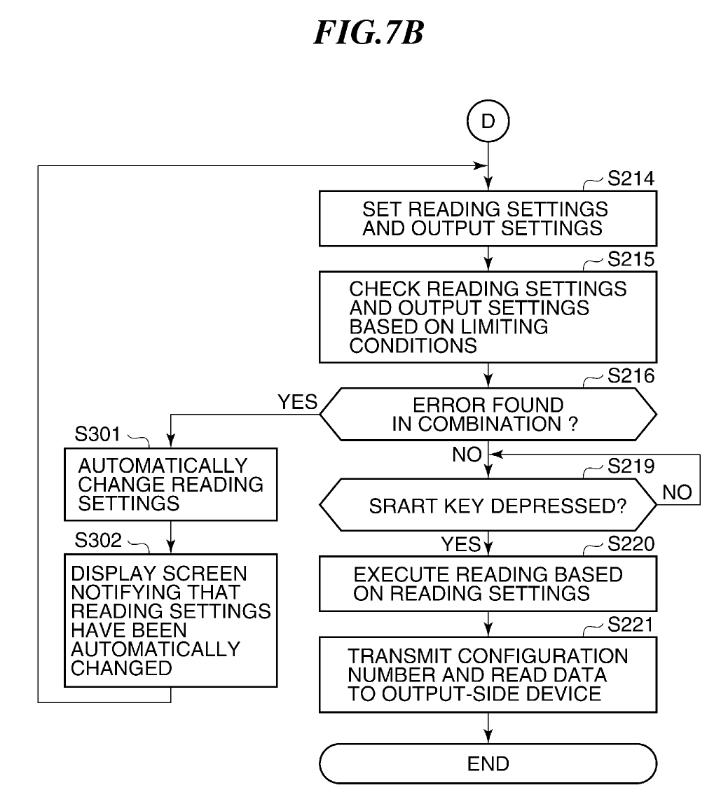

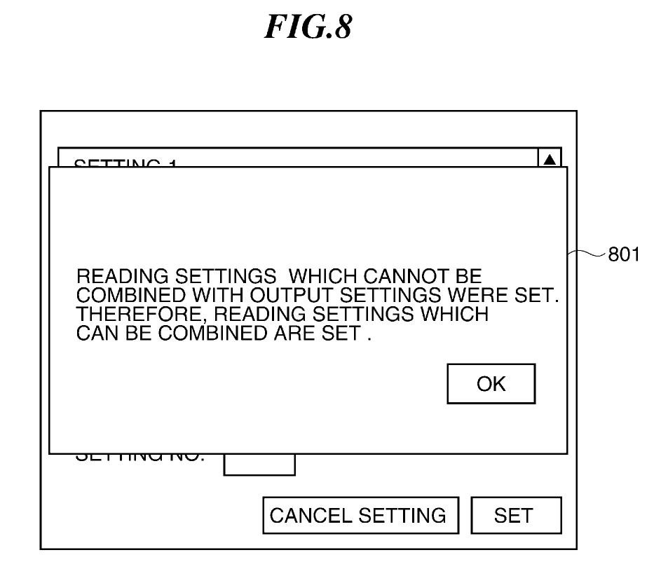

FIGS. 7A and 7B is a flowchart of a first variation of the read-side device collaboration process executed by the digital multifunction peripheral (device A) on the read side as the image processing apparatus according to the embodiment shown in FIG. 1 in collaboration with the digital multifunction peripheral on the output side (device B) which has the same configuration as the device A. The present process is executed by the CPU 101 by reading the associated program from the HDD 104 and loading the same into the RAM 102. FIG. 8 illustrates a message screen displayed in a step S302 in FIG. 7B.

The present variation differs from the above-described embodiment only in a portion of the read-side device collaboration process executed when it is determined in the step S216 that there is an error found in the combination. In this variation, as shown in FIGS. 7A and 7B, the present configuration of reading settings is automatically changed to a configuration of reading settings which can be combined with the selected configuration of output settings under the limiting conditions (step S301). After automatically changing the configuration of reading settings, a message screen 801 shown in FIG. 8 notifying an error message that the configuration of reading settings has been automatically changed is displayed (step S302), and the process proceeds to the step S214. The other steps are identical to those in FIGS. 3A and 3B, and hence a description thereof is omitted.

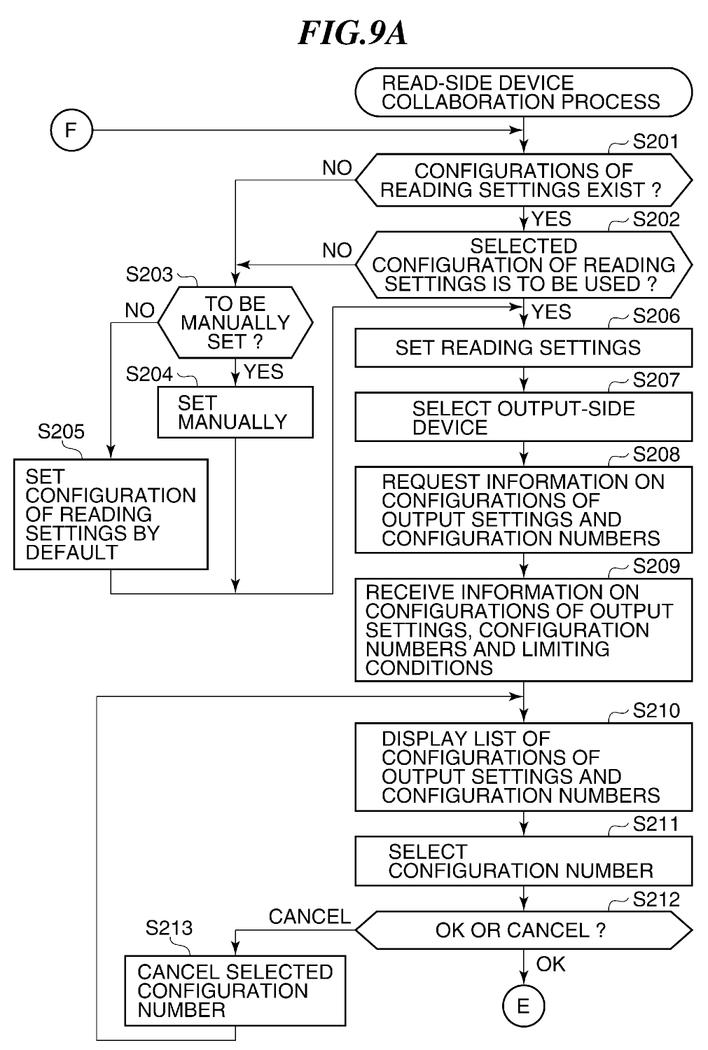

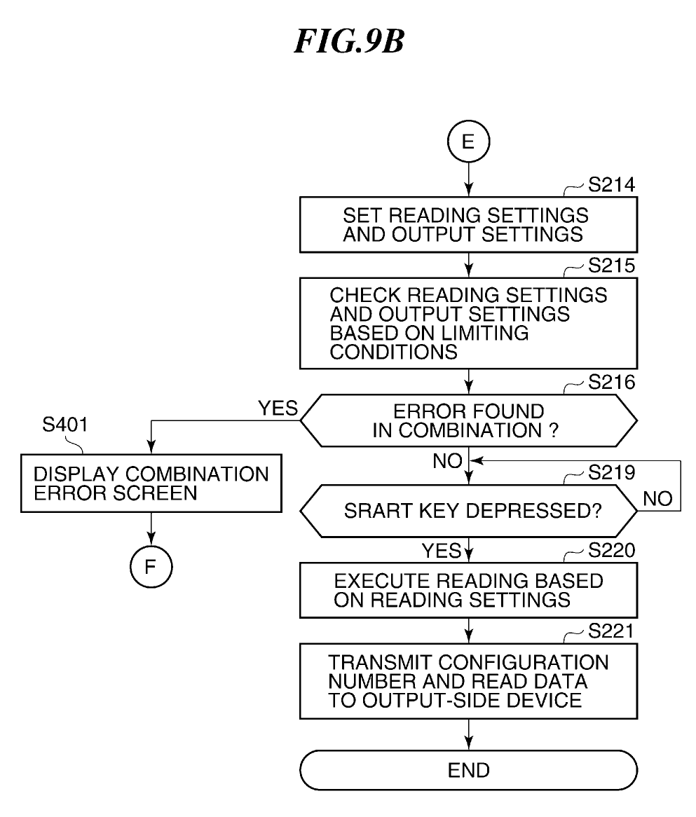

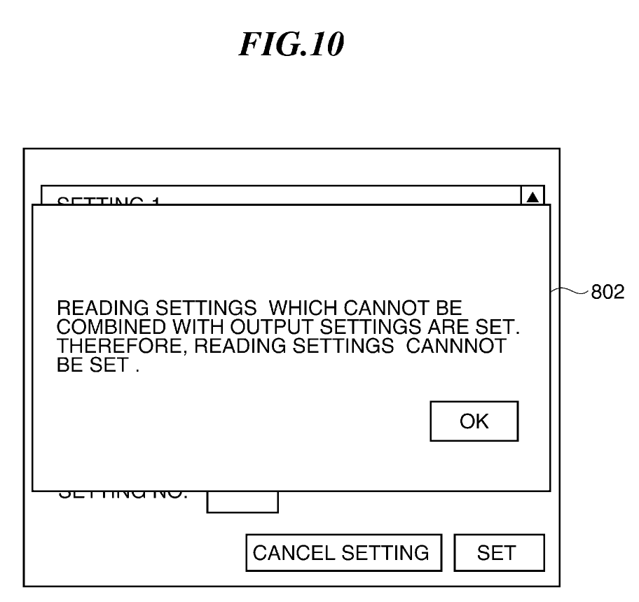

FIGS. 9A and 9B are a flowchart of a second variation of the read-side device collaboration process executed by the digital multifunction peripheral (device A) on the read side as the image processing apparatus according to the embodiment shown in FIG. 1 in collaboration with the digital multifunction peripheral on the output side (device B) which has the same configuration as the device A. The present process is executed by the CPU 101 by reading the associated program from the HDD 104 and loading the same into the RAM 102. FIG. 10 illustrates an error screen displayed in a step S401 in FIG. 9B.

The present variation differs from the above-described embodiment only in a portion of the read-side device collaboration process executed when it is determined in the step S216 that there is an error found in the combination. In this variation, as shown in FIGS. 9B and 10, an error screen 802 saying an error message that an error has been found in the combination is displayed (step S401). After displaying the error screen 802 in the step S401, the process returns to the step S201 again to repeat the present process from the start. The other steps are identical to those in FIGS. 3A and 3B, and hence a description thereof is omitted.

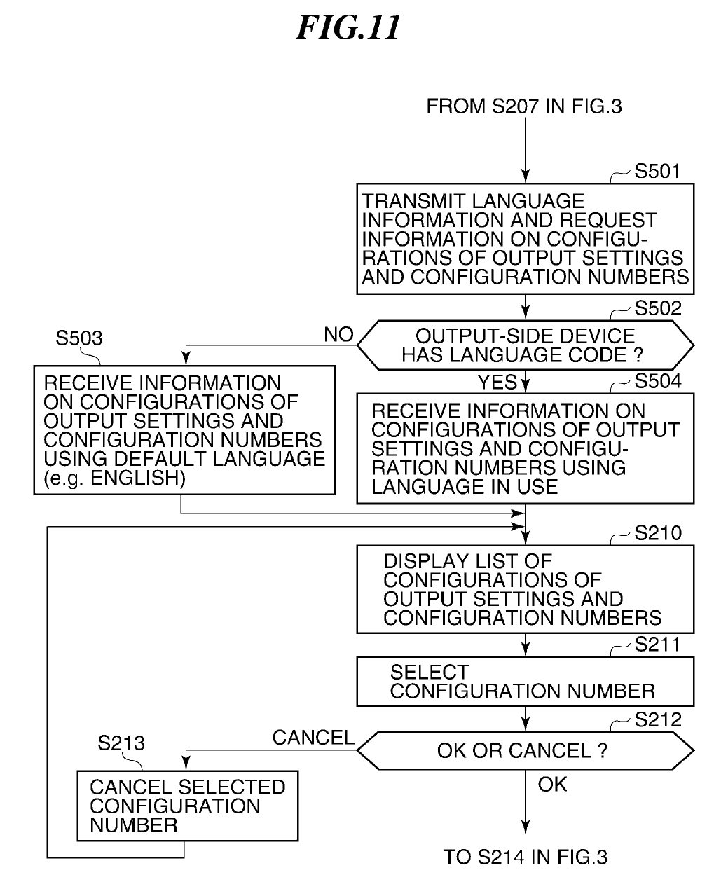

FIG. 11 is a flowchart of essential parts of a third variation of the read-side device collaboration process executed by the digital multifunction peripheral (device A) on the read side as the image processing apparatus according to the embodiment shown in FIG. 1 in collaboration with the digital multifunction peripheral on the output side (device B) which has the same configuration as the device A. The read-side device collaboration process is executed by the CPU 101 by reading the associated program from the HDD 104 and loading the same into the RAM 102.

In the present variation, the read-side device collaboration process is executed while taking into consideration a display language used in the read-side device. More specifically, the steps S208 and S209 in FIG. 3A are replaced by steps S501 to S504 the description of which will be given hereafter with reference to FIG. 11 illustrating the replaced portion.

First, after an output-side device is selected in the step S207 in FIG. 3A, a request for information on the configurations of output settings and the associated configuration numbers is transmitted to the output-side device in a step S501. At this time, information on the display language of the read-side device is also sent to the output-side device together with the request.

Next, in a step S502, it is determined whether or not the output-side device has a language code corresponding to the information on the display language sent from the read-side device in the step S501. This determination is performed in the following manner. Based on the information on the display language of the read-side device sent in the step S501 together with the request, the output-side device determines whether or not the output-side device has a language code corresponding to the display language of the read-side device, and although omitted from illustration, the read-side device receives a result of the determination, which is sent from the output-side device, and then performs the determination in the step S502 based on the received result of the determination.

If it is determined in the step S502 that the output-side device has a language code corresponding to the display language of the read-side device, the process proceeds to a step S504, wherein the read-side device receives information on the configurations of output settings and the associated configuration numbers from the output-side device using the language.

If it is determined in the step S502 that the output-side device does not have a language code corresponding to the display language of the read-side device, the process proceeds to a step S503, wherein the read-side device receives information on the configurations of output settings and the associated configuration numbers from the output-side device using a default language (e.g. English in this example) set in advance.

After the information on the configurations of output settings and the associated configuration numbers are received in the step S503 or S504, the steps S210 et seq. which are the same as those in FIGS. 3A and 3B are executed.

In the present invention, information on one of configurations of output settings registered in advance in the output-side device is selected, and hence it is not necessary to be aware of existence of required compatible functions of the output-side device, and further, it is possible to save time and labor to configure detailed settings of the output-side device at the read-side device. Further, even when a new function is added to the output-side device, it is possible to use the new function of the output-side device without newly adding a definition to the read-side device.

Further, the limiting conditions on the configuration of reading settings for performing output according to a selected configuration of output settings of the output-side device are transmitted to the read-side device, whereby it is possible to combine a configuration of reading settings and a configuration of output settings at the read-side device while taking the limiting conditions into consideration.

It is to be understood that the present invention may also be realized by supplying a system or an apparatus with a storage medium in which a program code of software, which realizes the functions of the above described embodiment is stored, and causing a computer (or CPU or MPU) of the system or apparatus to read out and execute the program code stored in the storage medium.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-227130, filed Sep. 30, 2009, which is hereby incorporated by reference herein in its entirety.

What is claimed is:

1. An image processing apparatus as a read-side device that reads image data, and instructs an output-side device to output the read image data, comprising:
a selection unit configured to select the output-side device;
a request unit configured to request the output-side device selected by said selection unit to transmit information on output settings;
a reception unit configured to receive the information on the output settings requested by said request unit and limiting conditions on reading settings for executing the output settings, from the output-side device;
an execution unit configured to execute reading of image data based on the reading settings with the limiting conditions received by said reception unit; and
a transmission unit configured to transmit the image data read by said execution unit and the information on the output settings, to the output-side device.

2. The image processing apparatus as claimed in claim 1,
wherein the information on the output settings received by said reception unit comprises a plurality of pieces of information on respective configurations of output settings,
the image processing apparatus further comprising:
a display unit configured to display the plurality of pieces of information on the configurations of output settings in a selectable manner;
an input unit configured to input the reading settings;
a determination unit configured to determine whether or not there is an error in a combination of a selected one of the configurations of output settings and the input reading settings; and
a changing unit configured to change the reading settings when it is determined by said determination unit that there is an error in the combination.

3. The image processing apparatus as claimed in claim 2, wherein said changing unit changes the reading settings either based on an instruction of a user or automatically.

4. The image processing apparatus as claimed in claim 2, wherein said display unit displays an error message when it is determined by said determination unit that there is an error in the combination.

5. The image processing apparatus as claimed in claim 1, wherein the limiting conditions include a reading resolution.

6. The image processing apparatus as claimed in claim 1, wherein the limiting conditions include a reading color.

7. The image processing apparatus as claimed in claim 1, wherein the limiting conditions include a reading size.

8. The image processing apparatus as claimed in claim 1, wherein said request unit transmits information on a display language to the output-side device in addition to a request for transmitting the information on output settings, and
wherein said reception unit receives the information on the output setting and the limiting conditions on the reading settings for executing the output settings from the output-side device, using the display language.

9. The image processing apparatus as claimed in claim 8, wherein if the output-side device does not have a language code corresponding to the display language, said reception unit receives the information on the output settings and the limiting conditions on the reading settings for executing the output settings from the output-side device, using a default language set in advance.

10. A method of controlling an image processing apparatus as a read-side device that reads image data, and instructs an output-side device to output the read image data, comprising:
selecting the output-side device;
requesting the output-side device selected by said selecting to transmit information on output settings;
receiving the information on the output settings requested by said requesting and limiting conditions on reading settings for executing the output settings, from the output-side device;
executing reading of image data based on the reading settings with the limiting conditions received by said receiving; and
transmitting the image data read by said executing and the information on the output settings, to the output-side device.

11. A non-transitory computer-readable storage medium storing a computer-executable program for causing a computer to execute a method of controlling an image processing apparatus as a read-side device that reads image data, and instructs an output-side device to output the read image data,
wherein the method comprises:
selecting the output-side device;
requesting the output-side device selected by said selecting to transmit information on output settings;
receiving the information on the output settings requested by said requesting and limiting conditions on reading settings for executing the output settings, from the output-side device;
executing reading of image data based on the reading settings with the limiting conditions received by said receiving; and
transmitting the image data read by said executing and the information on the output settings, to the output-side device.
